(19) United States
(12) Patent Application Publication
(10) Pub. No.: US 2011/0002132 A1
(43) Pub. Date: Jan. 6, 2011

(54) IRRADIATION ANGLE ADJUSTER FOR STREET LIGHT

(76) Inventor: Young Min PARK, Siheung-si (KR)

Correspondence Address: Jae Y. Park, Kile, Park, Goekjian, Reed & McManus, PLLC, 1200 New Hampshire Ave. NW, Suite 570, Washington, DC, 20036, US

(21) Appl. No.: 12/719,596

(22) Filed: Mar. 8, 2010

(30) Foreign Application Priority Data
Jul. 3, 2009 (KR) 20-2009-0008617

(51) Int. Cl. F21V 21/14

(52) U.S. Cl. 362/429

(57) ABSTRACT

Disclosed herein is an irradiation angle adjuster for a street light which enables one to adjust an angle of light emitted from a lamp. The adjuster includes an arm coupling part, a boss coupling part, a boss, a lamp mounting part and a worm gear. The arm coupling part is coupled to the arm of the street light. The boss coupling part is provided on the arm coupling part. Coupling protrusions are provided at both sides on the boss coupling part. The boss is coupled between the coupling protrusions. Gear teeth are formed on the rear surface of the boss. The lamp mounting part is provided on the front surface of the boss. The lamp is mounted to the lamp mounting part. The worm gear is installed in the boss coupling part and engages with the gear teeth of the boss to transmit rotating force to the boss.

### CROSS REFERENCE TO RELATED APPLICATION

This application claims the benefit of Korean Patent Application No. 20-2009-0008617, filed Jul. 3, 2009, entitled “Adjuster of irradiation angle for street light”, which is hereby incorporated by reference in its entirety into this application.

### BACKGROUND OF THE INVENTION

1. Technical Field

The present invention relates generally to irradiation angle adjusters for street lights and, more particularly, to an irradiation angle adjuster for a street light which is constructed such that an angle of light emitted from a lamp can be adjusted by rotating a worm gear.

2. Description of the Related Art

Generally, street lights are illumination apparatuses which are installed on the edges of a road for the sake of the safety and security of road traffic. Depending on an installation location (for example, an expressway, a general roadway, a sidewalk, a residential street, etc.), an appropriate kind of street light is used.

As shown in FIG. 1, most street lights include a lamppost 70 which is pegged into and placed upright in the ground, an arm 80 which is coupled to or integrally formed with the upper end of the lamppost 70, and a lamp 90 which is coupled to the front (distal) end of the arm 80.

However, such a conventional street light is problematic in that the illumination effect may not be satisfactory depending on the circumference, such as an installation place or location, the grade of the ground, etc.

The reason for this is that because the orientation of the arm 80 of the street light is fixed at a predetermined angle, the angle of light emitted from the lamp 90 cannot be adjusted.

### SUMMARY OF THE INVENTION

The present invention has been made in an effort to provide an irradiation angle adjuster for a street light which is constructed such that an angle of light emitted from a lamp can be adjusted in response to the circumference of the place on which the street light is installed.

In order to accomplish the above object, the present invention provides an irradiation angle adjuster provided to a street light having a lamppost, an arm and a lamp, the irradiation angle adjuster adjusting an angle of light emitted from the lamp and including: an arm coupling part coupled to a front end of the arm; a boss coupling part coupled to or integrally formed with a front end of the arm coupling part, with coupling protrusions provided at both sides on a front surface of the boss coupling part; a boss coupled between the coupling protrusions by a coupling bolt and a nut, with gear teeth formed on a rear surface of the boss; a lamp mounting part coupled to or integrally formed with a front surface of the boss, the lamp mounting part supporting the lamp; and a worm gear installed in the boss coupling part, the worm gear engaging with the gear teeth of the boss to transmit rotating force to the boss.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a side view showing a conventional street light;

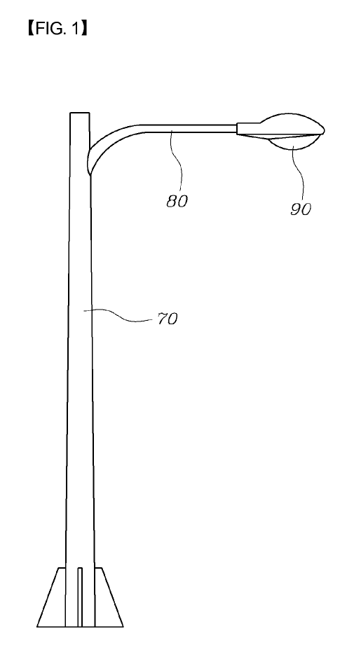

FIG. 2 is a side view of a street light provided with an irradiation angle adjuster according to a first embodiment of the present invention;

FIG. 3 is a perspective view of the irradiation angle adjuster according to the first embodiment of the present invention;

FIG. 4 is an exploded perspective view of FIG. 3;

FIG. 5 is a bottom perspective view of FIG. 4;

FIG. 6 is of side sectional views showing the operation of the irradiation angle adjuster according to the first embodiment of the present invention; and

FIG. 7 is a side section view of an irradiation angle adjuster for a street light, according to a second embodiment of the present invention.

### DESCRIPTION OF THE PREFERRED EMBODIMENTS

Hereinafter, preferred embodiments of the present invention will be described in detail with reference to the attached drawings.

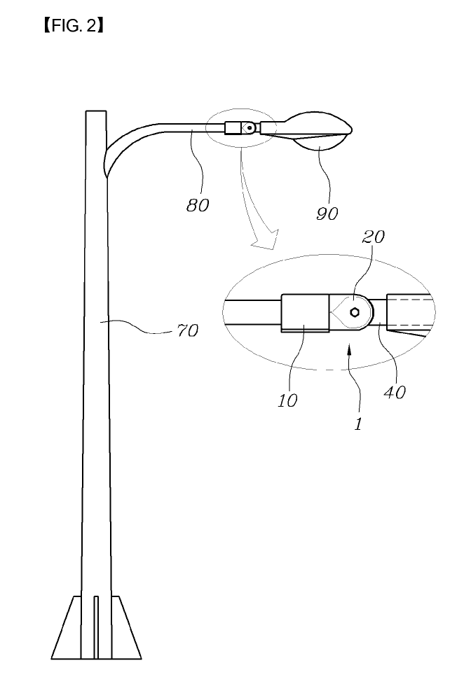

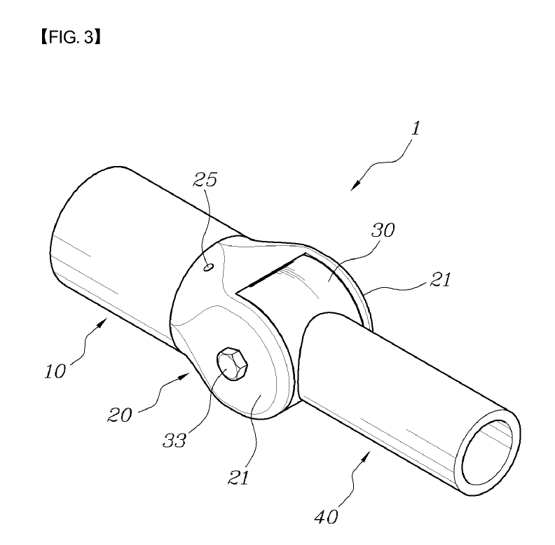

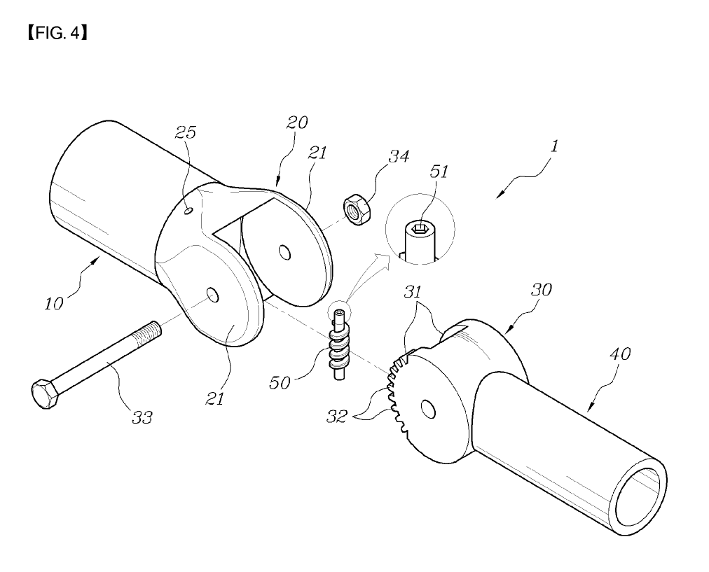

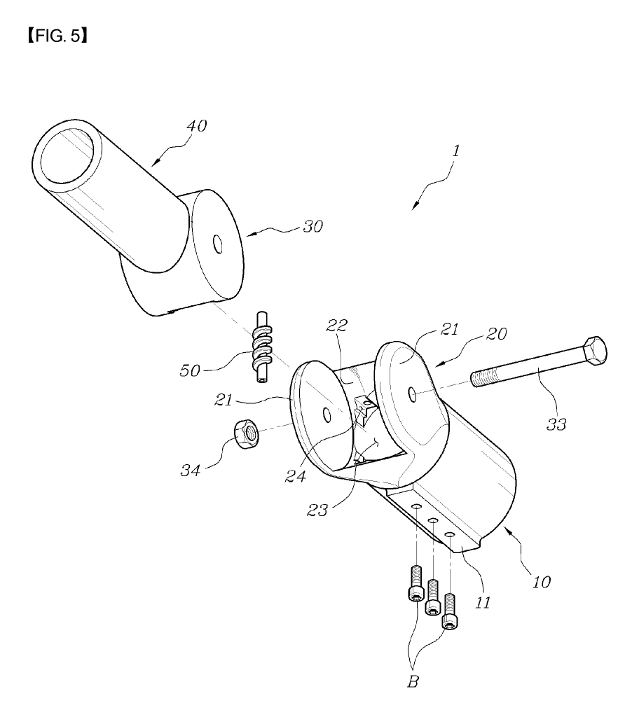

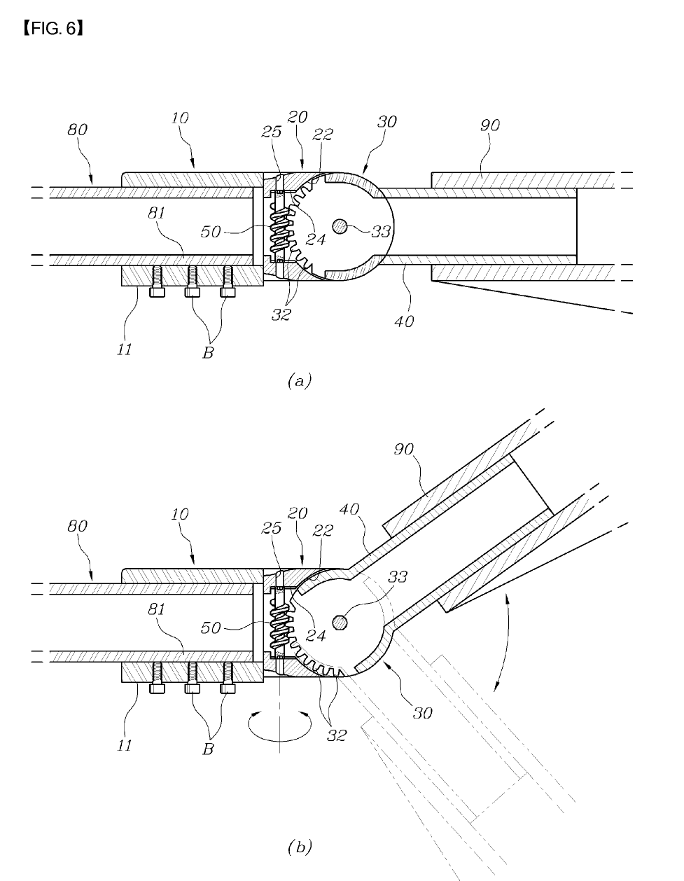

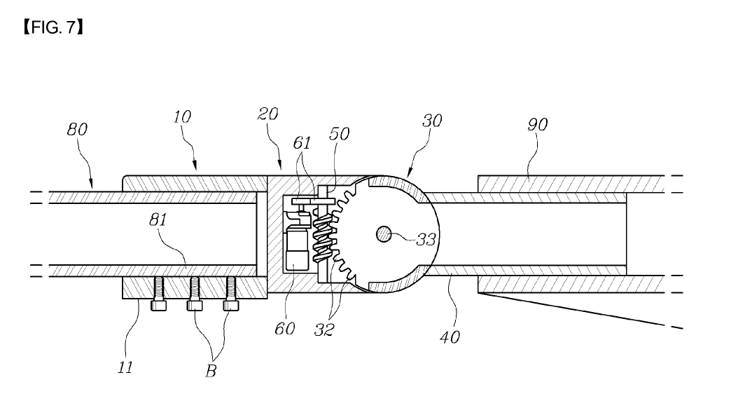

FIG. 2 is a side view of a street light provided with an irradiation angle adjuster according to a first embodiment of the present invention. FIG. 3 is a perspective view of the irradiation angle adjuster 1 according to the first embodiment of the present invention. FIG. 4 is an exploded perspective view of FIG. 3. FIG. 5 is a bottom perspective view of FIG. 4. FIG. 6 is of side sectional views showing the operation of the irradiation angle adjuster 1 according to the first embodiment of the present invention. FIG. 7 is a side section view of an irradiation angle adjuster for a street light, according to a second embodiment of the present invention.

As shown in FIGS. 2 through 6, the irradiation angle adjuster 1 according to the first embodiment of the present invention includes an arm coupling part 10, a boss coupling part 20, a boss 30, a lamp mounting part 40 and a worm gear 50.

As shown in FIG. 2, the irradiation angle adjuster 1 is installed on a street light which has a typical structure including a lamppost 70 which is pegged into the ground and placed upright, an arm 80 which is coupled to or integrated with the upper end of the lamppost 70, and a lamp 90 which is coupled to a front (distal) end 81 of the arm 80. The irradiation angle adjuster 1 is provided between the arm 80 and the lamp 90 to adjust the angle between the arm 80 and the lamp 90.

In detail, the arm coupling part 10 is coupled to the front end 81 of the arm 80. The arm coupling part 10 has a pipe shape corresponding to the shape of the front end 81 of the arm 80 and is fitted over the front end 81 of the arm 80. Referring to FIG. 5, a bolt coupling surface 11 protrudes from the outer surface of the arm coupling part 10 and extends along the longitudinal direction of the arm coupling part 10. The arm coupling part 10 is fastened to the front end 81 of the arm 80 by tightening bolts B through the bolt coupling surface 11 of the arm coupling part 10. Here, the above-mentioned coupling structure between the arm 80 and the arm coupling part 10 is only an example for illustrative purposes. For example, as necessary, the arm coupling part 10 may be coupled to the arm 80 in such a way that coupling holes are formed through the arm 80 and the arm coupling part 10 and a pin or bolt is inserted into the coupling holes. Alternatively, the arm coupling part 10 may be coupled to the arm 80 by welding the rear end of the arm coupling part 10 to the outer surface of the arm 80. As such, various examples can be used as the method of coupling the arm coupling part 10 to the arm 80.

The boss coupling part 20 is provided on the front end of the arm coupling part 10. The boss coupling part 20 may be integrally formed with the arm coupling part 10 or coupled thereto by welding. Semicircular coupling protrusions 21 are provided on the front end of the boss coupling part 20 at opposite sides of the center axis thereof. A round surface 22 is formed on the inner surface of the boss coupling part 20 between the semicircular coupling protrusions 21. Furthermore, a hollow hole 23 is formed through the central portion of the round surface 22 of the boss coupling part 20. The hollow hole 23 communicates with the inner space formed in the arm coupling part 10. Seating depressions 24 are formed at predetermined positions in the junction between the inner surface of the hollow hole 23 and the round surface 22. The worm gear 50 which will be explained later is seated into the seating depressions 24.

The boss 30 is rotatably coupled between the semicircular coupling protrusions 21 by a coupling bolt 33 and a nut 34. The boss 30 has a cylindrical shape and is open on the medial portion of the rear surface 31 thereof, so that the plan cross-section thereof has a “U” shape. Thus, the rear surface 31 of the boss 30 is divided into two opposite parts and seated into the round surface 22. Furthermore, gear teeth 32 which engage with the worm gear 50 are formed on the part of the rear surface 31 which is adjacent to the seating depressions 24. Here, the boss 30 may be coupled to the boss coupling part 20 by a hinge shaft. More preferably, the boss is coupled to the semicircular coupling protrusions 21 using the coupling bolt 33 and the nut 34 such that the boss comes into contact with the semicircular coupling protrusions 21 so as to prevent the boss 30 from undesirably moving attributable to a clearance between the boss 30 and the semicircular coupling protrusions 21 or backlash occurring between the worm gear 50 and the gear teeth 32.

The lamp mounting part 40 is provided on the front surface of the boss 30. The lamp mounting part 40 has a pipe shape. In the same manner as the coupling structure between the arm coupling part 10 and the boss coupling part 20, the lamp mounting part 40 may be integrally formed with boss 30 or coupled thereto by welding. The lamp mounting part 40 functions to hold the lamp 90. As shown in FIG. 6, the lamp 90 may be mounted to the lamp mounting part 40 by fitting the front end of the lamp mounting part 40 into the lamp 90. As necessary, a bracket may be provided on the front end of the lamp mounting part 40 so that the lamp 90 is mounted to the lamp mounting part 40 by the bracket. Here, it is preferable that the lamp mounting part 40 have the same shape as that of the front end 81 of the arm 80. In this case, because the lamp mounting part 40 of each irradiation angle adjuster 1 can be connected to the arm coupling part 10 of another irradiation angle adjuster 1, when many irradiation angle adjusters 1 are stored or carried, the handling of the irradiation angle adjusters 1 can be facilitated.

As stated above, the worm gear 50 is seated into the seating depressions 24 and engages with the gear teeth 32 formed on the boss 30. The worm gear 50 transmits rotating force to the boss 30. A hexagonal depression 51 is formed in one end or each of both ends of the worm gear 50, so that the worm gear 50 can be rotated using a wrench inserted into the hexagonal depression 51. Furthermore, a through hole 25 is formed through the portion of the outer surface of the boss coupling part 20 that corresponds to each hexagonal depression 51, such that the wrench can access the hexagonal depression 51 through the through hole 25.

The operation of the irradiation angle adjuster 1 according to the first embodiment of the present invention having the above-mentioned construction will be explained below.

The street light provided with the irradiation angle adjuster 1 of the present invention is installed on the edge of a road. The wrench is inserted into the through hole 25 formed in the boss coupling part 20 to rotate the worm gear 50. When the worm gear 50 is rotated, the boss 30 which engages with the worm gear 50 is rotated around the coupling bolt 33. Thereby, the lamp 90 which is mounted to the lamp mounting part 40 is rotated. Therefore, the angle of light emitted from the lamp 90 can be adjusted in response to the circumferences of the place on which the street light is installed. After the worm gear 50 is rotated such that the lamp 90 is oriented at a desired angle, the nut 34 is tightened over the coupling bolt 33 so that the boss coupling parts 20 come into close contact with and reliably hold the boss 30, thus completing the adjustment of the irradiation angle of the lamp 90.

Furthermore, according to the characteristics of the irradiation angle adjuster 1 of the present invention, the lamp mounting part 40 has the same shape as that of the front end 81 of the arm 80. Hence, the irradiation angle adjuster 1 of the present invention can be easily mounted to an existing street light in such a manner that the lamp 90 is separated from the arm 80 of the existing street light and the irradiation angle adjuster 1 is installed between the arm 80 and the lamp 90.

Meanwhile, as shown in FIG. 7, in the second embodiment of the present invention, a drive motor 60 is installed in a boss coupling part 20. In consideration of the irradiation angle adjuster 1 being typically disposed at a relatively high position, the drive motor 60 enables to easily manipulate the irradiation angle adjuster 1 even on the ground. Preferably, a geared motor is used as the drive motor 60. Referring to the drawing, in the embodiment, the drive motor 60 is fastened to the bottom of the boss coupling part 20 and coupled to the worm gear 50 through a gear 61. However, the present invention is not limited to this. For example, the drive motor 60 may be installed in the arm coupling part 10. In addition, the drive motor 60 may be connected to the worm gear 50 through various power transmission units, such as a chain, belt, etc.

As described above, the present invention provides an irradiation angle adjuster which enables adjustment of the angle between an arm of a street light and a lamp, so that the angle of light emitted from the lamp can be appropriately adjusted depending on the circumferences of the place on which the street light is installed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An irradiation angle adjuster provided to a street light having a lamppost, an arm and a lamp, the irradiation angle adjuster adjusting an angle of light emitted from the lamp and comprising:
an arm coupling part coupled to a front end of the arm;
a boss coupling part coupled to or integrally formed with a front end of the arm coupling part, with coupling protrusions provided at both sides on a front surface of the boss coupling part;
a boss coupled between the coupling protrusions by a coupling bolt and a nut, with gear teeth formed on a rear surface of the boss;
a lamp mounting part coupled to or integrally formed with a front surface of the boss, the lamp mounting part supporting the lamp; and
a worm gear installed in the boss coupling part, the worm gear engaging with the gear teeth of the boss to transmit rotating force to the boss.

2. The irradiation angle adjuster as set forth in claim 1, wherein the arm coupling part has a pipe shape corresponding to a shape of the front end of the arm such that the arm coupling part is fitted over the front end of the arm, and the lamp mounting part has the same shape as the shape of the front end of the arm such that the lamp mounting part is able to be inserted into an arm coupling part of another irradiation angle adjuster.

3. The irradiation angle adjuster as set forth in claim 1, further comprising:
a drive motor provided in the arm coupling part or the boss coupling part, the drive motor rotating the worm gear.
